(19) United States
(12) Patent Application Publication
(10) Pub. No.: US 2020/0371054 A1
(43) Pub. Date: Nov. 26, 2020

(54) Method and Apparatus for Predicting Thermal Runaway Safety of Power Battery and Computer Readable Storage Medium

(71) Applicant: TSINGHUA UNIVERSITY, Beijing (CN)

(72) Inventors: Dongsheng Ren, Beijing (CN); Xiang Liu, Beijing (CN); Xuning Feng, Beijing (CN); Languang Lu, Beijing (CN); Minggao Ouyang, Beijing (CN); Jianqiu Li, Beijing (CN)

(21) Appl. No.: 16/633,628

(22) PCT Filed: Nov. 2, 2018
(86) PCT No.: PCT/CN2018/113561

§ 371 Date: Jan. 24, 2020

(30) Foreign Application Priority Data
Feb. 7, 2018 (CN) 201810122868.7

(51) Int. Cl. G01N 25/48; H01M 10/48; H01M 10/42; B60L 58/10; B60L 50/64

(52) U.S. Cl. CPC G01N 25/4866; G01N 25/4826; H01M 10/486; H01M 4/587; B60L 58/10; B60L 50/64; H01M 10/4285

(57) ABSTRACT

A method and an apparatus (11) for predicting thermal runaway safety of a power battery and a computer readable storage medium are provided. The method includes: obtaining initial battery temperature of a first power battery; conducting calculation to obtain temperature of the first power battery that has undergone thermal shock for duration; and determining, based on a power battery thermal runaway model, whether thermal runaway occurs on the first power battery.

### CROSS-REFERENCE TO RELATED APPLICATIONS

This application claims priority to Chinese Patent Application No. 201810122868.7, filed on Feb. 7, 2018 and entitled “METHOD AND APPARATUS FOR PREDICTING THERMAL RUNAWAY SAFETY OF POWER BATTERY AND COMPUTER READABLE STORAGE MEDIUM”, which is incorporated herein by reference in its entirety.

### TECHNICAL FIELD

This application relates to the battery field, and more specifically, to a method and an apparatus for predicting thermal runaway safety of a power battery and a computer readable storage medium.

### BACKGROUND

Electric vehicles are the mainstay of new energy vehicles, and power battery is the core energy source of an electric vehicle. A lithium-ion power battery (referred to as a “power battery” below) has advantages of high energy/power density and long service life, and is the most widely used electrochemical power source for vehicles. Due to limited in-vehicle space, to increase a cruising range of an electric vehicle, it is also necessary to increase specific energy of power batteries in addition to installing more power batteries in the in-vehicle space. To increase specific energy of batteries, a variety of new material systems have been developed in exemplary technologies. However, these new material systems need to satisfy a series of industry standards including life and safety standards and the like when being used in large-scale industrialization of batteries. When a safety accident occurs on a power battery with higher specific energy, energy released by the power battery due to thermal runaway is more concentrated. Therefore, during the design and development of power batteries with high specific energy, the thermal runaway safety of batteries produced in large scale must be ensured.

Generally, when evaluating the thermal runaway safety of a new battery material, a battery designer needs to produce a specific number (dozens) of batteries containing the material and then conduct a series of safety tests on the batteries, to evaluate the thermal runaway safety of the battery material. In this example method for evaluating the thermal runaway safety of batteries by using experiments, the battery designer has to assemble the power batteries and conduct a lot of safety tests. Approximately several kilograms of electrode materials and a large amount of manpower and material resources are required to prepare batteries and conduct safety tests, which is not conducive to improving the development efficiency of battery design.

### SUMMARY

In view of this, it is necessary to provide a method and an apparatus for predicting thermal runaway safety of a power battery and a computer readable storage medium based on a problem in which many materials are consumed and battery development efficiency is low in a conventional method for predicting thermal runaway of a power battery.

The method for predicting thermal runaway safety of a power battery, including:

S10. obtaining initial battery temperature of a first power battery;

S20. selecting duration in which the first power battery undergoes thermal shock, and conducting calculation based on a power battery thermal runaway model according to the initial battery temperature to obtain temperature of the first power battery that has undergone thermal shock for the duration; and

S30. comparing the temperature of the first power battery that has undergone thermal shock for the duration with a standard value of thermal runaway, and determining whether thermal runaway occurs on the first power battery.

In the method for predicting thermal runaway safety of a power battery provided in this application, the initial battery temperature of the first power battery is first obtained; the duration in which the first power battery undergoes thermal shock is then selected; calculation is conducted based on the power battery thermal runaway model according to the initial battery temperature to obtain the temperature of the first power battery that has undergone thermal shock for the duration; and finally the temperature of the first power battery that has undergone thermal shock for the duration is compared with the standard value of thermal runaway, and whether thermal runaway occurs on the first power battery is determined. The power battery thermal runaway model is used to determine whether thermal runaway occurs on the first power battery, so as to reduce a waste of battery materials and reduce costs. This is conducive to improving the development efficiency of battery design.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a flowchart of a method for predicting thermal runaway safety of a power battery according to an embodiment of this application;

FIG. 2 is a curve chart of a differential scanning calorimetry (DSC) test of a test sample at a single heating rate according to an embodiment of this application;

FIG. 3 is a DSC test curve chart, obtained at a plurality of heating rates, of a sample formed by a cathode material and an anode material according to an embodiment of this application;

FIG. 4 is a comparison diagram of DSC test experimental results obtained at a plurality of heating rates and calculation results of a cathode material and an anode material according to an embodiment of this application;

FIG. 5 is a comparison diagram of a prediction result obtained by using a power battery thermal runaway model and an actual experimental result according to an embodiment of this application;

FIG. 6 is a comparison diagram of a prediction result obtained by using a power battery thermal runaway model and an actual experimental result according to an embodiment of this application; and

FIG. 7 is a structural diagram of an apparatus for predicting thermal runaway safety of a power battery according to an embodiment of this application.

### DETAILED DESCRIPTION

The technical solutions of the embodiments of the present application are clearly and completely described below with reference to the accompanying drawings of the embodiments of the present application. Apparently, the described embodiments are some rather than all of the embodiments of the present application. All other embodiments obtained by those of ordinary skill in the art based on the embodiments of the present invention without creative efforts shall fall within the protection scope of the present invention.

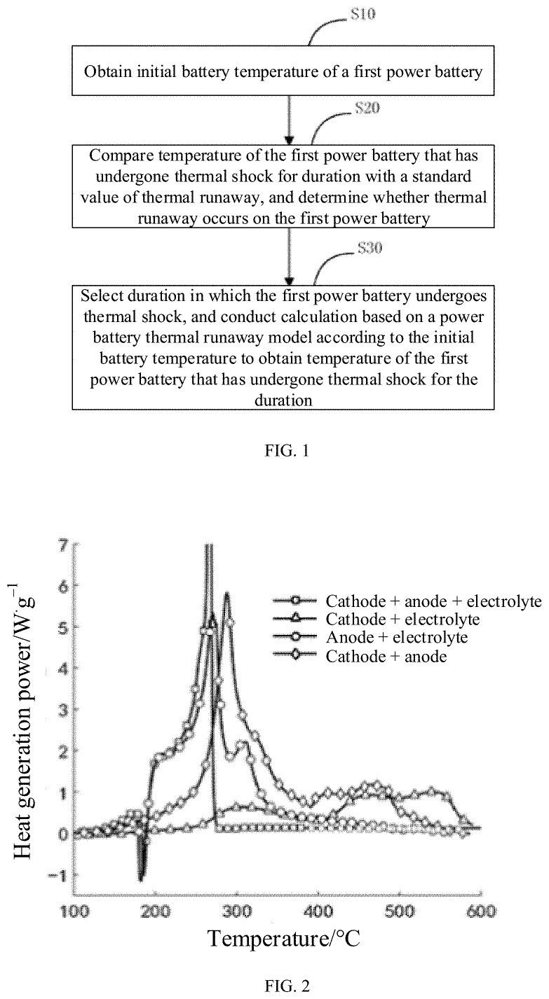

Referring to FIG. 1, an embodiment of this application provides a method for predicting thermal runaway safety of a power battery. The method for predicting thermal runaway safety of a power battery includes the following steps:

S10. Obtain initial battery temperature of a first power battery.

S20. Select duration in which the first power battery undergoes thermal shock, and conduct calculation based on a power battery thermal runaway model according to the initial battery temperature to obtain temperature of the first power battery that has undergone thermal shock for the duration.

S30. Compare the temperature of the first power battery that has undergone thermal shock for the duration with a standard value of thermal runaway, and determine whether thermal runaway occurs on the first power battery.

In this embodiment, in S10, the initial battery temperature of the first power battery may be initial temperature of the first power battery that has not undergone thermal shock.

In S20, the duration in which the first power battery undergoes thermal shock is duration in which the first power battery is in a specific thermal shock condition. The thermal shock may be impact of a high-temperature environment on the first power battery. The power battery thermal runaway model may be used to calculate temperature of the first power battery that has undergone thermal shock for a period of time.

In S30, whether thermal runaway occurs on the first power battery may be determined according to the standard value. The standard value may be set according to an empirical value. The standard value may be a critical value for determining whether thermal runaway occurs on the first power battery. When the temperature of the first power battery that has undergone thermal shock for the duration is less than the standard value, it can be determined that thermal runaway does not occur on the first power battery in this thermal shock condition. When the temperature of the first power battery that has undergone thermal shock for the duration is larger than the standard value, it can be determined that thermal runaway is prone to occur on the first power battery in this thermal shock condition.

In an embodiment, the standard value may include three substandard values: a “high, medium, and low” substandard value. The “high, medium, and low” substandard value may be determined according to temperature data values. The “high, medium, and low” substandard value may decrease successively. Based on the three substandard values, a thermal runaway risk of the first power battery may be classified into four levels:

When temperature data of the first power battery is greater than the “high” substandard value, it indicates that the thermal runaway risk of the first power battery is the highest.

When the temperature data of the first power battery is between the “high” substandard value and the “medium” substandard value, it indicates that the thermal runaway risk of the first power battery is relatively high.

When the temperature data of the first power battery is between the “medium” substandard value and the “low” substandard value, it indicates that the thermal runaway risk of the first power battery is relatively low.

When the temperature data of the first power battery is less than the “low” substandard value, it indicates that the thermal runaway risk of the first power battery is the lowest.

In the method for predicting thermal runaway safety of a power battery provided in this embodiment of this application, the initial battery temperature of the first power battery is first obtained; the duration in which the first power battery undergoes thermal shock is then selected; calculation is conducted based on the thermal runaway model of a power battery according to the initial battery temperature to obtain the temperature of the first power battery that has undergone thermal shock for the duration; and finally the temperature of the first power battery that has undergone thermal shock for the duration is compared with the standard value of thermal runaway, and whether thermal runaway occurs on the first power battery is determined. The power battery thermal runaway model is used to determine whether thermal runaway occurs on the first power battery, so as to reduce a waste of battery materials and reduce costs. This is also conducive to improving the development efficiency of battery design.

In an embodiment, a method for establishing the power battery thermal runaway model includes the following steps:

S210. Fabricate a second power battery.

S220. Disassemble the fully charged second power battery to obtain a cathode material and an anode material of the second power battery to prepare a test sample.

S230. Conduct a differential scanning calorimetry (DSC) test on the test sample to obtain test temperature data and test heat generation power data of the test sample.

S240. Calculate reaction kinetic parameter values of the test sample based on the test temperature data and the test heat generation power data.

S250. Establish the power battery thermal runaway model based on a reaction kinetics equation by using a principle of mass balance, an energy balance equation, and the kinetic parameter values.

In this embodiment, in S210, the second power battery may be a half cell fabricated based on a material for fabricating the first power battery, or may be a model battery of the first power battery. Therefore, the power battery thermal runaway model established based on the second power battery can be used to predict a thermal runaway status of the first power battery. During fabrication of the second power battery, a required cathode active material, anode active material, binder, conductive agent, electrolyte, and separator may be determined according to requirements of capacity, energy, and the like. A ratio of the various materials is accordingly determined. During fabrication of a positive plate and a negative plate, electrode active materials, a conductive agent, and a binder are mixed according to specified ratios, and mixed evenly into pastes, coated evenly on current collectors, and finally compacted, cut, and dried to obtain the positive plate and the negative plate.

In an embodiment, the used cathode active material of the battery is a ternary cathode active material (LiₓNi_{1/3}Co_{1/3}Mn_{1/3}O₂), the anode active material is graphite, the conductive agent is acetylene black, the binder is polyvinylidene fluoride (PVDF), a cathode current collector is aluminum foil, and an anode current collector is copper foil. A ratio for a cathode of the second power battery is:the ternary cathode active material:the conductive agent:the binder=95:3:2. A ratio for an anode of the second power battery is:the active material:the conductive agent:the binder=85:5:10. In an embodiment, a separator used for the first power battery is a polyethylene (PE) separator with a single surface coated with ceramic, and the electrolyte is formed by a lithium salt LiPF₆ and an organic solvent. The positive plate is used as the cathode, the negative plate is used as the anode, an appropriate amount of electrolyte is added, and the separator is placed to fabricate the second power battery. In an embodiment, the second power battery may be a small-capacity lithium-ion power battery, or may be a coin cell, a small pouch-type battery, or a small prismatic battery. In an embodiment, a capacity of a small power battery is less than 100 mAh. After the second power battery is fabricated, formation is conducted on the second power battery, so that stable interface protective films are formed on surfaces of the positive plate and the negative plate of the second power battery.

In an embodiment, step S220 includes:

S310. Disassemble the fully charged second power battery in a glovebox filled with argon gas to obtain a positive plate and a negative plate that are fully charged.

S320. Scrape the positive plate and the negative plate from current collectors, and grind the positive plate and the negative plate to obtain the cathode material and the anode material.

In an embodiment, before step S320, the method further includes:

S311. Soak the obtained positive plate and negative plate in a dimethyl carbonate solution.

In S220, the charge-discharge test is conducted on the fabricated second power battery, and a state of charge of the second power battery is adjusted to a fully charged state. In an embodiment, the second power battery is charged to 4.2 V by using a low current in a constant-voltage constant-current charging mode, so that the state of charge of the second power battery is adjusted to the fully charged state. In an embodiment, the fully charged second power battery may be disassembled in the glovebox filled with argon gas to obtain a positive plate and a negative plate that are fully charged. Before a DSC test sample is prepared, the obtained positive plate and negative plate may be soaked in the dimethyl carbonate solution for a period of time (usually, half an hour), and then the plates are washed to remove residual lithium salts and dried. The whole process may be conducted in the glovebox. Then, the positive plate and the negative plate are scraped from the current collectors, and then are gently ground to obtain positive plate powder and negative plate powder. The positive plate powder and the negative plate powder may be respectively used as the cathode material and the anode material.

In an embodiment, the second power battery includes second electrolyte. The second electrolyte may be electrolyte applicable to the second power battery. The test sample includes a first sample formed by the second electrolyte, the cathode material, and the anode material; a second sample formed by the second electrolyte and the cathode material; a third sample formed by the anode material and the second electrolyte; and a fourth sample formed by the cathode material and the anode material. According to thermal decomposition reactions that may occur in the first power battery and a mass ratio of a cathode, an anode, and electrolyte set during design of the first power battery, the first sample, the second sample, the third sample, and the fourth sample can be obtained by means of mixing. In an embodiment, compositions of the four samples are as follows:
the first sample: the cathode material (6 mg)+the anode material (3.4 mg)+the electrolyte (3 mg);
the second sample: the cathode material (6 mg)+the electrolyte (3 mg);
the third sample: the anode material (3.4 mg)+the electrolyte (3 mg); and
the fourth sample: the cathode material (6 mg)+the anode material (3.4 mg).

In an embodiment, S230 includes:

S231. Select a heating rate value, and conduct a DSC test on each of the first sample, the second sample, the third sample, and the fourth sample according to the heating rate value, to obtain a set of first test temperature data and a set of first test heat generation power data corresponding to the first test temperature data.

S232. Conduct screening on the first sample, the second sample, the third sample, and the fourth sample according to the first test temperature data and the first test heat generation power data to select main exothermic reaction samples.

S233. Select a plurality of heating rate values, and conduct a plurality of DSC tests on each of the main exothermic reaction samples according to the plurality of heating rate values, to obtain a plurality of sets of second test temperature data and a plurality of sets of second test heat generation power data in one-to-one correspondence with the second test temperature data.

In S231, the obtained first sample, second sample, third sample, and fourth sample may be placed in sample preparation crucibles of a differential scanning calorimeter, and are sealed. In an embodiment, material samples such as a separator and electrolyte used for the first power battery may be placed in sample preparation crucibles of the differential scanning calorimeter in a glovebox, and the crucibles are sealed.

In an embodiment, the differential scanning calorimeter is used, a heating rate value is selected, and DSC tests are conducted on the first sample, the second sample, the third sample, and the fourth sample. The selected heating rate value may be any one of 0.5° C./min, 1° C./min, 2° C./min, 5° C./min, 10° C./min, 15° C./min, and 20° C./min. For a sample y, an obtained DSC test result includes a set of first test temperature data T_{y}, first test heat generation power data Q_{y} corresponding to the first test temperature data T_{y}, and a test time t_{y}.

In S232, DSC test results of the four samples are compared, so as to determine main exothermic reaction sample in a battery thermal runaway process. In an embodiment, FIG. 2 shows DSC test results of the obtained four samples. Heat generation power data Q_{y} in FIG. 2 is in unit of W·g⁻¹. The unit W·g⁻¹ may be a result obtained by dividing a total mass of the cathode material, the anode material, and the electrolyte (that is, 12.4 mg) from generated heat. It can be seen from FIG. 2 that the first sample releases a large amount of heat at approximately 260° C., and instantaneous heat generation power is very high and beyond a measurement range of the instrument. It can be found through comparison of DSC test results of the other three samples that, heat generated in the battery at an earlier stage is mainly from the third sample formed by the anode material and the electrolyte, and when temperature is higher than 200° C., the fourth sample formed by the cathode material and the anode material also starts to release heat. The second sample formed by the second electrolyte and the cathode material release very little heat. Therefore, it can be determined that main exothermic reactions inside the battery are reactions of the third sample formed by the anode material and the electrolyte and the fourth sample formed by the cathode material and the anode material. In other words, the main exothermic reaction samples may be the third sample and the fourth sample.

In S233, the differential scanning calorimeter may be used to conduct a plurality of DSC tests on the main exothermic reaction samples at different heating rates. In an embodiment, at least four DSC tests may be conducted at different heating rates. The selected heating scanning rates may be four of 0.5° C./min, 1° C./min, 2° C./min, 5° C./min, 10° C./min, 15° C./min, and 20° C./min. In other words, four DSC tests may be conducted on each main exothermic reaction sample at different heating rates. In an embodiment, the differential scanning calorimeter may be used to conduct DSC tests on the separator used in the second power battery at a plurality of heating rates. In an embodiment, DSC tests may be conducted on the third sample and the fourth sample at four heating rates. The selected heating rates may be 5° C./min, 10° C./min, 15° C./min, and 20° C./min. DSC tests may be conducted at four heating rates, to obtain four sets of second test temperature data of each of the third sample and the fourth sample and four sets of second test heat generation power data in one-to-one correspondence with the second test temperature data.

In an embodiment, S240 includes:

S241. Obtain temperature-power relation curves of the plurality of sets of second test temperature data and the plurality of sets of second test heat generation power data based on the plurality of sets of second test temperature data and the plurality of sets of second test heat generation power data in one-to-one correspondence with the second test temperature data.

S242. Obtain a number of exothermic reactions of each main exothermic reaction sample based on the temperature-power relation curves.

S243. Calculate the kinetic parameter values of the exothermic reaction of each main exothermic reaction sample according to a mass balance equation, a heat release power calculation formula, a heat generation power calculation formula, the reaction kinetics equation, the temperature-power relation curves, and the number of exothermic reactions of each main exothermic reaction sample by using a numerical optimization method.

In S242, in an embodiment, DSC tests may be conducted on the sampley. It can be determined, according to the temperature-power relation curves, that a plurality of exothermic reactions may occur on the sample y. Subscripts of the exothermic reactions x may be marked as x=y_1, x=y_2, x=y_3, and the like.

In an embodiment, main exothermic reactions x of the two samples, that is, the anode material+the electrolyte and the cathode material+the anode material, in a high temperature condition, and their corresponding symbols are shown in Table 1:

TABLE 1
Main exothermic reactions x and their corresponding
symbols in this embodiment of this application

| Reaction | Symbol | | Symbol of the |
|---|---|---|---|
| system y | of y | Exothermic reaction x | reaction x |
| Anode + | An + Ele | Decomposition reaction | An + Ele_1 |
| electrolyte | | of a solid electrolyte | |
| | | interface film | |
| | | Reaction between the | An + Ele_2 |
| | | anode and the electrolyte | |
| | | Reaction between the | An + Ele_3 |
| | | anode and a binder | |
| Cathode + | Ca + An | Reaction between the | Ca + An_1 |
| anode | | cathode and the anode | |
| | | Reaction between the | Ca + An_2 |
| | | cathode and a binder | |
| | | Cathode decomposition | Ca + An_3 |
| | | reaction | |
| Separator | Sep | Separator melting | Sep |

In an embodiment, for each main exothermic reaction x, and a reaction kinetics equation is established and is in the following form:

$$\frac{d {c}_{x}}{dt} = {A}_{x} \cdot exp ( - \frac{{E}_{a , x}}{R \cdot T} ) \cdot {c}_{x}^{{n}_{x}} \qquad ( 1 )$$

where x represents the exothermic reaction in the test sample; cₓ represents a normalized concentration of a reactant of the exothermic reaction and is in a unit of 1; Aₓ represents a pre-frequency factor of the reaction and is in a unit of s⁻¹, E_{a, x} represents activation energy of the reaction and is in a unit of J·mol⁻¹; R is an ideal gas constant 8.314 J·mol⁻¹ nₓ is a reaction order and is in a unit of 1, where Aₓ, E_{a, x}, and nₓ are reaction kinetic parameters of the exothermic reaction x.

In an embodiment, during the exothermic reaction, a concentration of the reactant of the exothermic reaction follows the mass balance equation:

$${c}_{x} = 1 - \int \frac{d {c}_{x}}{dt} dt \qquad ( 2 )$$

In an embodiment, correspondingly, the heat release power calculation formula of the exothermic reaction x is:

$${Q}_{x} = m \cdot {H}_{x} \cdot \frac{d {c}_{x}}{dt} \qquad ( 3 )$$

where Qₓ represents heat release power of the exothermic reaction x; m is a sum of the mass of the cathode material, the anode material, and the electrolyte and is in a unit of g; and Hₓ is reaction enthalpy of the exothermic reaction x and is in a unit of J·g⁻¹.

Heat generation power of the sample y is a sum of heat release power of main exothermic reactions, and a calculation formula of the heat generation power is:

Q_{y}=Q_{y_1}+Q_{y_2}+Q_{y_3}+ . . . (4)

In the formula, y may represent the main exothermic reaction sample, and y_1, y_2, and y_3 may represent exothermic reactions of the main exothermic reaction sample.

According to DSC test results obtained at a plurality of heating rates, when a set of reaction kinetic parameters [Aₓ, E_{a,x}, nₓ, Hₓ] of the exothermic reaction x of the main exothermic reaction sample is given, temperature-power relation curves of a plurality of sets of test heat generation power data Q_{y} and a plurality of sets of test temperature data T_{y} of the main exothermic reaction sample at different heating rates can be obtained through calculation. By setting up simultaneous equations: formulas (1) to (4), and a numerical optimization method is used to make an error between the temperature-power relation curves obtained through calculation and DSC test curves obtained through experiments be the smallest, that is, reaction kinetic parameters [Aₓ, E_{a,x}, nₓ, Hₓ] of each exothermic reaction x of the main exothermic reaction sample can be calculated.

In an embodiment, the numerical optimization method may be a particle swarm optimization method, a genetic algorithm, or a least square method.

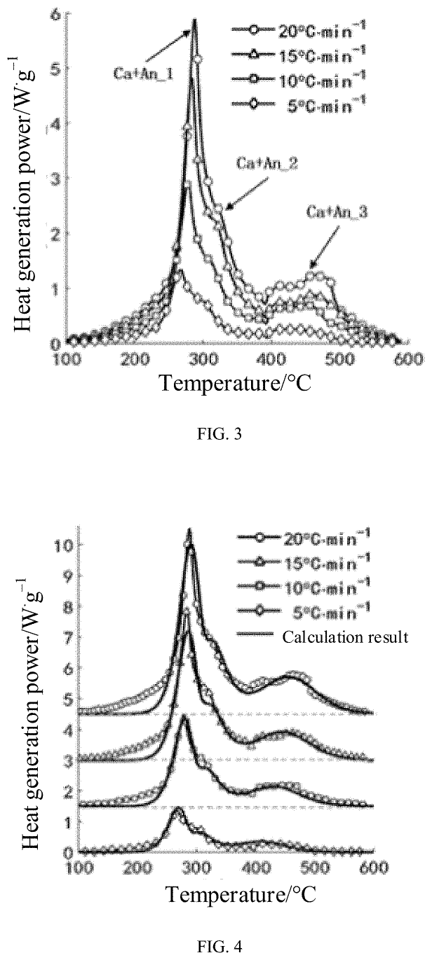

In an embodiment, when the main exothermic reaction sample y corresponds to the fourth sample formed by the cathode material and the anode material (that is, y=Ca+An), four DSC tests may be conducted on the fourth sample at different heating rates. The four heating rates may be {5° C./min, 10° C./min, 15° C./min, 20° C./min}. FIG. 3 shows calorimetry test results of the fourth sample that are obtained at four different heating rates.

Exothermic reactions of the fourth sample are respectively marked as Ca+An_1, Ca+An_2, and Ca+An_3. Then, based on formulas (1) to (4), for the exothermic reactions Ca+An_1, Ca+An_2, and Ca+An_3 of the fourth sample, a least square method is used to make an error between a plurality of temperature-power relation curves obtained through calculation and DSC test curves obtained through experiments be the smallest, that is, reaction kinetic parameters [Aₓ, E_{a,x}, nₓ, Hₓ] of the exothermic reaction x of the main exothermic reaction sample can be calculated. A set of obtained optimal reaction kinetic parameters is shown in Table 2.

TABLE 2
Reaction kinetic parameters and reaction enthalpy of all
main reactions in this embodiment of this application

| | | | | Reaction |
|---|---|---|---|---|
| Symbol of a | Reaction kinetic parameters | | | enthalpy |
| reaction x | Aₓ[s⁻¹] | E_{a, x}[J · mol⁻¹] | nₓ[1] | Hₓ[J · g⁻¹] |
| An + Ele_1 | 6.3623 × 10⁹ | 1.0960 × 10⁵ | 5.5 | 578.7 |
| An + Ele_2 | 5.1510 × 10¹⁷ | 2.0077 × 10⁵ | 1 | 253.2 |
| An + Ele_3 | 4.9679 × 10¹⁵ | 1.9549 × 10⁵ | 1 | 108.5 |
| Ca + An_1 | 2.4262 × 10¹³ | 1.6201 × 10⁵ | 1 | 578.7 |
| Ca + An_2 | 6.5429 × 10¹³ | 1.7785 × 10⁵ | 2 | 434.0 |
| Ca + An_3 | 5.3481 × 10⁵ | 1.0934 × 10⁵ | 1.5 | 434.0 |
| Sep | 6.74 × 10⁴⁴ | 3.69 × 10⁵ | 1 | −15 |

FIG. 4 shows a calculation result obtained by substituting the foregoing optimal parameters into formulas (1) to (4). It can be seen that the calculation result in FIG. 4 is very close to an experimental result, which indicates that the calculated reaction kinetic parameters are relatively appropriate.

Based on a mass balance equation of reactants, a connection between the main reactions in the thermal runaway process of the second power battery is established.

$$\frac{dT}{dt}$$

In an embodiment, according to the energy conservation equation, a heating rate of the power battery is:

$$\frac{d T}{d t} = \frac{Q + h \cdot A \cdot ( {T}_{A} - T )}{M \cdot {C}_{p}} \qquad ( 5 )$$

where h is a convective heat transfer coefficient between a battery and an environment; A is a heat-exchange area; T_{A} is environment temperature; M is the mass of the second power battery; and Q is a sum of heat released by main reactions and satisfies the following formula:

$$Q = {\sum }_{x} {Q}_{x} \qquad ( 6 )$$

Qₓ is calculated by setting up simultaneous equations: formulas (1) to (3).

In this way, the following model for predicting thermal runaway safety of a power battery may be established:

$$T 1 = {\int }_{t} \frac{dT}{dt} dt + {T}_{0} \qquad ( 7 )$$

T₀ is the initial battery temperature, and T₁ is the temperature of the first power battery that has undergone thermal shock for the duration.

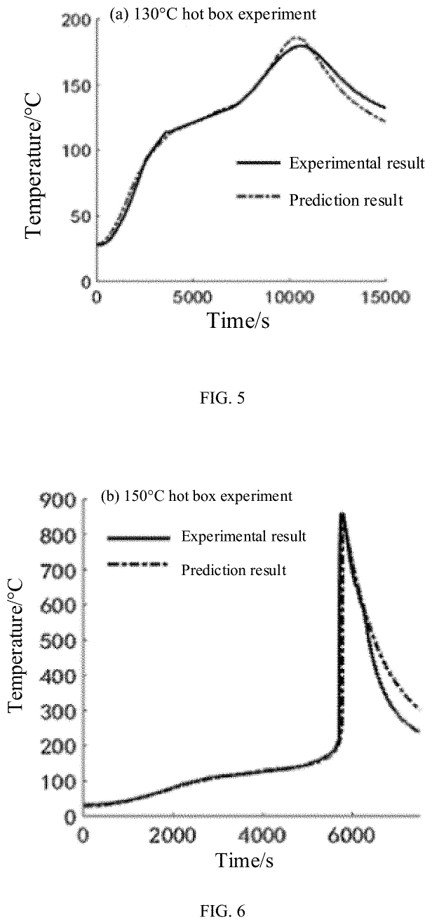

Based on the model for predicting thermal runaway safety of a power battery, thermal runaway characteristics of the first power battery that has undergone different thermal shock may be predicted. FIG. 5 shows comparison of an experimental result of a 130° C. hot box experiment and a prediction result of the first power battery in an embodiment of this application. It can be seen that, the result obtained through the method for predicting thermal runaway safety of a power battery is very consistent with the experimental result. The first power battery can safely pass the 130° C. hot box experiment, and thermal runaway does not occur. FIG. 6 shows comparison of an experimental result of a 150° C. hot box experiment and a prediction result of the first power battery in an embodiment of this application. It can be seen that, the result obtained through the method for predicting thermal runaway safety of a power battery is very consistent with the experimental result. The first power battery cannot pass the 150° C. hot box experiment, and finally thermal runaway occurs.

It can learned with reference to FIG. 5 and FIG. 6 that, the method for predicting thermal runaway safety in this application can accurately predict temperature responses of the first power battery that has undergone different thermal shock, and prediction accuracy is very high. The method for predicting thermal runaway safety of a power battery in this application can accurately predict thermal runaway safety of a full battery based on DSC tests on few materials, and can be used to guide safety design and model selection of a battery material.

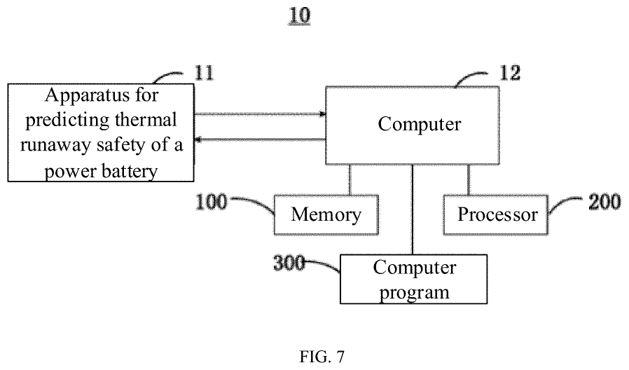

Referring to FIG. 7, an embodiment of this application further provides an apparatus 10 for predicting thermal runaway safety of a power battery. The apparatus 10 for predicting thermal runaway safety of a power battery includes a device 11 for predicting thermal runaway safety of a power battery and a computer 12. The computer 12 includes a memory 100, a processor 200, and a computer program 300 that is stored in the memory 200 and that can be run in the processor 200. When the processor 200 executes the computer program 300, a method for predicting thermal runaway safety of a power battery is implemented. The method includes:

S10. obtaining initial battery temperature of a first power battery;

S20. selecting duration in which the first power battery undergoes thermal shock, and conducting calculation based on a power battery thermal runaway model according to the initial battery temperature to obtain temperature of the first power battery that has undergone thermal shock for the duration; and

S30. comparing the temperature of the first power battery that has undergone thermal shock for the duration with a standard value of thermal runaway, and determining whether thermal runaway occurs on the first power battery.

An embodiment of this application further provides a computer readable storage medium, where the computer readable storage medium stores a computer program. When being executed by a processor, the program can be used to conduct steps of the foregoing method.

A person of ordinary skill in the art can understand that all or a part of processes of the method in the foregoing embodiment may be completed through a computer program or instruction related hardware. The program may be stored in a computer readable storage medium, and when being executed, the program may be used to implement processes of each method embodiment in the foregoing. For any reference used for a memory, a storage, a database, or other mediums used in various embodiments provided in this application may include a nonvolatile memory and/or a volatile memory. The nonvolatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As description rather than limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronization link (Synchlink) DRAM (SLDRAM), a Rambus (Rambus) direct RAM (RDRAM), a direct Rambus dynamic RAM (DRDRAM), and a Rambus dynamic RAM (RDRAM).

Finally, it should be further noted that, in this specification, relationship terms such as first and second are only used to distinguish an entity or operation from another entity or operation, but do not necessarily require or imply that there is any actual relationship or order between these entities or operations. In addition, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device. In the case that there are no more restrictions, an element limited by the statement “includes a . . . ” does not exclude the presence of additional identical elements in the process, the method, the article, or the device that includes the element.

Each embodiment of the present specification is described in a progressive manner, each embodiment focuses on the difference from other embodiments, and the same and similar parts between the embodiments may refer to each other.

The above illustration of the disclosed embodiments can enable a person skilled in the art to implement or practice the present invention. Various modifications to these embodiments are readily apparent to a person skilled in the art, and the generic principles defined herein may be practiced in other embodiments without departing from the spirit or scope of the present invention. Thus, the present invention is not limited to the embodiments shown herein but falls within the widest scope consistent with the principles and novel features disclosed herein.

1. A method for predicting thermal runaway safety of a power battery, comprising:
obtaining initial battery temperature of a first power battery;
selecting duration in which the first power battery undergoes thermal shock, and conducting calculation based on a power battery thermal runaway model according to the initial battery temperature to obtain temperature of the first power battery that has undergone thermal shock for the duration; and
comparing the temperature of the first power battery that has undergone thermal shock for the duration with a standard value of thermal runaway, and determining whether thermal runaway occurs on the first power battery.

2. The method for predicting thermal runaway safety of a power battery according to claim 1, wherein a method for establishing the power battery thermal runaway model comprises:
fabricating a second power battery;
disassembling the fully charged second power battery to obtain a cathode material and an anode material to prepare a test sample;
conducting a differential scanning calorimetry (DSC) test on the test sample to obtain test temperature data and test heat generation power data of the test sample;
calculating reaction kinetic parameter values of the test sample based on the test temperature data and the test heat generation power data; and
establishing the power battery thermal runaway model based on a reaction kinetics equation by using a principle of mass balance, an energy balance equation, and the kinetic parameter values.

3. The method for predicting thermal runaway safety of a power battery according to claim 2, wherein the second power battery comprises second electrolyte, and the test sample comprises:
a first sample formed by the second electrolyte, the cathode material, and the anode material;
a second sample formed by the second electrolyte and the cathode material;
a third sample formed by the anode material and the second electrolyte; and
a fourth sample formed by the cathode material and the anode material.

4. The method for predicting thermal runaway safety of a power battery according to claim 3, wherein the step of conducting a differential scanning calorimetry (DSC) test on the test sample to obtain test temperature data and test heat generation power data of the test sample comprises:
selecting a heating rate value, and conducting a heating DSC test on each of the first sample, the second sample, the third sample, and the fourth sample according to the heating rate value, to obtain a set of first test temperature data and a set of first test heat generation power data corresponding to the first test temperature data;
conducting screening on the first sample, the second sample, the third sample, and the fourth sample according to the first test temperature data and the first test heat generation power data to select main exothermic reaction samples; and
selecting a plurality of heating rate values, and conducting a plurality of DSC tests on each of the main exothermic reaction samples according to the plurality of heating rate values, to obtain a plurality of sets of second test temperature data and a plurality of sets of second test heat generation power data in one-to-one correspondence with the second test temperature data.

5. The method for predicting thermal runaway safety of a power battery according to claim 4, wherein the step of calculating reaction kinetic parameter values of the test sample based on the test temperature data and the test heat generation power data comprises:
obtaining temperature-power relation curves of the plurality of sets of second test temperature data and the plurality of sets of second test heat generation power data based on the plurality of sets of second test temperature data and the plurality of sets of second-test heat generation power data in one-to-one correspondence with the second test temperature data;
obtaining a number of exothermic reactions of each main exothermic reaction sample based on the temperature-power relation curves; and
calculating the kinetic parameter values of the exothermic reaction of each main exothermic reaction sample according to a mass balance equation, a heat release power calculation formula, a heat generation power calculation formula, the reaction kinetics equation, the temperature-power relation curves, and the number of exothermic reactions of each main exothermic reaction sample by using a numerical optimization method.

6. The method for predicting thermal runaway safety of a power battery according to claim 5, the reaction kinetics equation is:
$$\frac{d {c}_{x}}{dt} = {A}_{x} \cdot exp ( - \frac{{E}_{a , x}}{R \cdot T} ) \cdot {c}_{x}^{{n}_{x}} \qquad ( 1 )$$
wherein x represents the exothermic reaction in the test sample; cₓ represents a normalized concentration of a reactant of the exothermic reaction and is in a unit of 1; Aₓ represents a pre-frequency factor of the reaction and is in a unit of s⁻¹; E_{a, x} represents activation energy of the reaction and is in a unit of J·mol⁻¹; R is ideal gas constant 8.314 J·mol⁻¹·K⁻¹; nₓ is a reaction order and is in a unit of 1, wherein Aₓ, E_{a, x}, and nₓ are reaction kinetic parameters of the exothermic reaction x; and T is reaction temperature.

7. The method for predicting thermal runaway safety of a power battery according to claim 6, the mass balance equation is:
$${c}_{x} = 1 - \int \frac{d {c}_{x}}{dt} dt \qquad ( 2 )$$
wherein cₓ represents a normalized concentration of a reactant of the exothermic reaction and is in a unit of 1.

8. The method for predicting thermal runaway safety of a power battery according to claim 7, the heat release power calculation formula is:
$${Q}_{x} = m \cdot {H}_{x} \cdot \frac{d {c}_{x}}{dt} \qquad ( 3 )$$
wherein Qₓ represents heat release power of the exothermic reaction x; m is a sum of the mass of the cathode material, the anode material, and the electrolyte and is in a unit of g; and Hₓ is reaction enthalpy of the exothermic reaction x and is in a unit of J·g⁻¹.

9. The method for predicting thermal runaway safety of a power battery according to claim 8, wherein
the heat generation power calculation formula is
Q_{y}=Q_{y_1}+Q_{y_2}+Q_{y_3}+ . . . (4)
wherein in the formula, y represents the main exothermic reaction sample, and y_1, y_2, and y_3 represent reactions of the main exothermic reaction sample.

10. The method for predicting thermal runaway safety of a power battery according to claim 9, wherein according to the energy conservation equation, a heating rate
$$\frac{d T}{d t}$$
of the power battery is:
$$\frac{d T}{d t} = \frac{Q + h \cdot A \cdot ( {T}_{A} - T )}{M \cdot {C}_{p}} \qquad ( 5 )$$
wherein h is a convective heat transfer coefficient between a battery and an environment; A is a heat-exchange area; T_{A} is environment temperature; T is battery temperature; M is the mass of the second power battery; and Q is a sum of heat released by main reactions and satisfies the following formula:
$$Q = {\sum }_{x} {Q}_{x} \qquad ( 6 )$$
wherein Qₓ is calculated by setting up simultaneous equations: formulas (1) to (3); and
the power battery thermal runaway model is
$$T 1 = {\int }_{t} \frac{dT}{dt} dt + {T}_{0} \qquad ( 7 )$$
wherein T₀ is the initial battery temperature; and T₁ is the temperature of the first power battery that has undergone thermal shock for the duration.

10. (canceled)

11. The method for predicting thermal runaway safety of a power battery according to claim 1, wherein the standard value comprises three substandard values: a high, medium, and low substandard value; the high, medium, and low substandard value are determined according to temperature data values; and temperature data values corresponding to the high, medium, and low substandard value decrease successively.

12. The method for predicting thermal runaway safety of a power battery according to claim 2, wherein a cathode active material of the second power battery is a ternary cathode active material.

13. The method for predicting thermal runaway safety of a power battery according to claim 2, wherein an anode active material of the second power battery is graphite.

14. The method for predicting thermal runaway safety of a power battery according to claim 2, wherein a conductive agent of the second power battery is acetylene black, and a binder is polyvinylidene fluoride.

15. The method for predicting thermal runaway safety of a power battery according to claim 2, wherein a cathode current collector of the second power battery is aluminum foil, and an anode current collector of the second power battery is copper foil.

16. The method for predicting thermal runaway safety of a power battery according to claim 2, wherein the second power battery is a lithium-ion power battery.

17. The method for predicting thermal runaway safety of a power battery according to claim 2, wherein the step of disassembling the fully charged second power battery to obtain a cathode material and an anode material to prepare a test sample comprises:
disassembling the fully charged second power battery in a glovebox filled with argon gas to obtain a positive plate and a negative plate that are fully charged; and
scraping the positive plate and the negative plate from current collectors, and grinding the positive plate and the negative plate to obtain the cathode material and the anode material,
preferably wherein, before the step of scraping the positive plate and the negative plate from the current collectors, the method comprises a step of soaking the obtained positive plate and negative plate in a dimethyl carbonate solution.

18. (canceled)

19. An apparatus for predicting thermal runaway safety of a power battery, comprising a device (11) for predicting thermal runaway safety of a power battery and a computer (12), wherein the computer (12) comprises a memory (100), a processor (200), and a computer program (300) that is stored in the memory (200) and that can be run in the processor (200); when the processor (200) executes the computer program (300), a method for predicting thermal runaway safety of a power battery is implemented; and the method comprises:
obtaining initial battery temperature of a first power battery;
selecting duration in which the first power battery undergoes thermal shock, and conducting calculation based on a power battery thermal runaway model according to the initial battery temperature to obtain temperature of the first power battery that has undergone thermal shock for the duration; and
comparing the temperature of the first power battery that has undergone thermal shock for the duration with a standard value of thermal runaway, and determining whether thermal runaway occurs on the first power battery.

20. A computer readable storage medium, wherein the computer readable storage medium stores a computer program, and when being executed by a processor, the program is used to conduct the foregoing steps:
obtaining initial battery temperature of a first power battery;
selecting duration in which the first power battery undergoes thermal shock, and conducting calculation based on a power battery thermal runaway model according to the initial battery temperature to obtain temperature of the first power battery that has undergone thermal shock for the duration; and
comparing the temperature of the first power battery that has undergone thermal shock for the duration with a standard value of thermal runaway, and determining whether thermal runaway occurs on the first power battery.

21. The method for predicting thermal runaway safety of a power battery according to claim 1, wherein the initial battery temperature of the first power battery is initial temperature of the first power battery that has not undergone thermal shock.
